(19) United States
(12) Patent Application Publication
(10) Pub. No.: US 2023/0275759 A1
(43) Pub. Date: Aug. 31, 2023

(54) METHOD AND SYSTEM OF ENCODING DATA OVER DISTRIBUTED NETWORKS AND METHOD OF ASSURING INTEGRITY OF DATA TRANSMISSION BETWEEN SENDER AND RECEIVER IN A COMMUNICATION SYSTEM

(71) Applicant: PHC LLC, McLean, VA (US)

(72) Inventor: ARUN MAJUMDAR, Lorton, VA (US)

(73) Assignee: PHC LLC, McLean, VA (US)

(21) Appl. No.: 17/947,440

(22) Filed: Sep. 19, 2022

Related U.S. Application Data
(60) Provisional application No. 63/246,785, filed on Sep. 21, 2021.

(51) Int. Cl. H04L 9/30

(52) U.S. Cl. CPC H04L 9/30

(57) ABSTRACT

In a system and method for encoding data for transmission, the data may be encoded using principles of superpositioning, holography and entanglement over a distributed network. The data is encoded into a virtual tokenized state, called a holographic token or Q-Token, an exists in a superposed, holographic and distributed form throughout the network. Unique properties of the holographic token include ultra-high integrity and availability to any node authorized to acquire the holographic token, while enabling cryptographic certification and rich data processing functionality. The example system is highly efficient, low-power, anti-fragile, and resilient to attacks of various kinds. The data encoded by the method and system cannot be cloned because the encoded data exists in a distributed form over the network. Hence, an intrinsic identity and integrity of the encoded data is preserved through all operations or catastrophes even to large parts of the distributed network or persistence structures.

### CROSS-REFERENCE TO RELATED APPLICATION

The present application claims priority under 35 U.S.C 119(e) to co-pending and commonly-assigned U.S. Provisional Patent Application Ser. No. 63/246,785 to the inventor, filed Sep. 21, 2021, the entire contents of which is hereby incorporated by reference herein.

### BACKGROUND

### Field

The example embodiments in general are directed to a system and one or more methods adapted for the encoding of data to be transmitted from sender to receiver over a distributed network such as a communication system using holographic principles that include polar coding, superimposed coding, and entanglement, and to a method of assuring integrity of data transmission between a sender and receiver in a communication system, each of the methods and system configured so as to achieve data integrity across the network or communication system.

### Related Art

Data integrity may be understood as the maintenance of, and the assurance of the accuracy and consistency of, data over its entire life-cycle. Data integrity is paramount to the design, implementation and usage of any computer system which stores, processes, or retrieves data.

Conventionally, approaches to data integrity have relied on redundancy in storage media and many forms of error-correcting-codes (ECC), where the arrangement of information for error correction is encoded in a way optimized for sequential access memory. However, classic codes, such as the Hamming Code and other ECC methods, do not consider all aspects of integrity, such as: availability, reliability, safety, dependability, resilience and maintainability. In fact, more modern concepts such as Anti-Fragility (a concept developed by Nassim Nicholas Taleb and described in his book “Antifragile” and technical papers) are not at all considered as a feature of data integrity, namely the survivability of data through catastrophe. Compromises are generally found through a complex combination of many techniques that result in a tower-of-Babel with significant computation overheads and inefficient performance metrics.

The codes in conventional encoding rely on the replication properties of parallel networks, or the codes build on what is called “split and expand operations” behind classic erasure codes in the case of serial networks. None of these coding techniques effectively leverage all the resources available in new and emerging modern encoding system designs, such as blockchain networks and other designs.

Some notable developments include the development of superimposed codes, polar codes (first described by Erdal Arikan in 2009 and which is a linear block error-correcting code with a code construction is based on a multiple recursive concatenation of a short kernel code which transforms the physical channel into virtual outer channels), and the emergence of coding ideas from quantum science as a source of thinking about new code types based on, for example, entanglement, or “quantum entanglement”, which is a physical phenomenon that occurs when a group of particles are generated, interact, or share spatial proximity in a way such that the quantum state of each particle of the group cannot be described independently of the state of the others, including when the particles are separated by a large distance.

Generally, local encoding does not deal efficiently with non-random errors, which include malicious attacks. However, concurrent coding (in general an encoding scheme with holographic' type properties) has been shown to deal with these errors more efficiently. Concurrent coding is a little-known technique originally developed by Baird, Bahn and Collins (BBC) as a way to offer a means of information encoding that could be made resistant to the effects of jamming (intentional or accidental) without the need for the communicating parties to encrypt their communications with a shared key, such as using CDMA.

First described in their paper “Jam-Resistant Communication Without Shared Secrets Through the Use of Concurrent Codes”, by Baird LC III, Bahn W L. & Collins M D, Technical Report, U. S. Air Force Academy, 2007, concurrent coding can be understood as an encoding scheme which distributes individual data words throughout an entire data set through the use of a hash function. In cryptography a hash function is a unique identifier for any given piece of content (data). The hash function is also a process that takes plain text data of any size and converts it into a unique cipher text of a specific length. In a more technical sense, a hash function is a versatile one-way cryptographic algorithm that maps an input of any size to a unique output of a fixed length of bits. The resulting output, which is known as a hash digest, hash value, or hash code, is the resulting unique identifier we mentioned.

Recall above that concurrent coding distributes individual data words throughout an entire data set using this hash function. The hashing function is then applied iteratively to increasing size prefixes of each data word to handle non-random errors more effectively. This solution from BBC has been shown to resist malicious injection attacks in some respects, such as one or more of the many types of distributed denial-of-service (DDoS) attacks.

In general a DDoS attack on a distributed network such as a communication system or channel is a malicious attempt to disrupt the normal traffic of a targeted server, service, or network by overwhelming the target or its surrounding infrastructure with a flood of Internet traffic. DDoS attacks achieve effectiveness by utilizing multiple compromised computer systems as sources of attack traffic. Exploited machines can include computers and other networked resources such as IoT devices.

From a high level, a DDoS attack is like an unexpected traffic jam clogging up the highway, preventing regular traffic from arriving at its destination. Examples of symptoms that reveal a present DDoS attack include (a) where a site or service suddenly becomes slow or unavailable; (b) suspicious amounts of traffic originating from a single IP address or IP range; (c) a flood of traffic from users who share a single behavioral profile, such as device type, geolocation, or web browser version; (d) an unexplained surge in requests to a single page or endpoint; and (e) odd traffic patterns such as spikes at odd hours of the day or patterns that appear to be unnatural (e.g., a spike every 10 minutes).

Different types of DDoS attacks target varying components of a network connection. A common type of attack is an application layer attack, sometimes referred to as a “layer 7 DDoS attack” (in reference to the 7th layer of the OSI model). The goal of application layer attacks is to exhaust the target's resources to create a denial-of-service. Another type is an HTTP flood attack. The flood attack (which range from simple to highly complex) is similar to pressing refresh in a web browser over and over on many different computers at once—large numbers of HTTP requests flood the server, resulting in denial-of-service.

A further common attack is a protocol attack. Protocol attacks, also known as state-exhaustion attacks, cause service disruption by over-consuming server resources and/or the resources of network equipment like firewalls and load balancers. Protocol attacks utilize weaknesses in layer 3 (network) and layer 4 (transport) of the OSI model to render the target inaccessible. Another common attacks is a SYN flood, which exploits the TCP handshake by sending a target a large number of TCP “Initial Connection Request” SYN packets with spoofed source IP addresses. The targeted machine responds to each connection request and then waits for the final step in the handshake, which never occurs, exhausting the target's resources in the process.

Other common attacks include volumetric and DNS amplification attacks. In a volumetric attack large amounts of data are sent to a target by using a form of amplification or another means of creating massive traffic, such as requests from a botnet. The goal of this attack is to create congestion by consuming all available bandwidth between the target and the larger Internet. A DNS amplification can be described in terms of a scenario where someone were to call a restaurant and say “I'll have one of everything, please call me back and repeat my whole order,” where the callback number actually belongs to the victim. With very little effort, a long response is generated and sent to the victim. By making a request to an open DNS server with a spoofed IP address (the IP address of the victim), the target IP address then receives a response from the server.

In the context of a communication system, recall that the classic Hamming Code and other ECC methods simply do not consider any of the availability, reliability, safety, dependability, resilience, and maintainability aspects of data integrity. Moreover, Taleb's concept of antifragility is not even a feature of data integrity across a distributed network, which is the survivability of data through catastrophe. Accordingly, for conventional, classic, and local encoding designs, the problem of anti-fragility remains. This is because a malicious attacker could simply increase its energy budget to continue the attack to a DDoS level such as one or more of the above-described DDoS attacks in combination, for which these conventional encoding measures simply cannot solve.

Therefore, what is needed is an encoding methodology, driven by a computing system to handle composable assets such as data that is to be transmitted with data integrity from a sender to a receiver across a distributed network such as a communication system. Such a system and method may encode the data (communication data, whether at rest or in motion) in a way that provides assured data transmission and/or data integrity across the network.

Namely such a solution would need to ensure that the data remains resistant to any kind of tampering, fragility, degradation, hacking, and corruption which may result from a DDoS attack. Such a solution for addressing the data integrity challenge must also deliver extreme confidentiality, integrity and availability. The solution must therefore satisfy a range of complex, interlocking requirements. Without being overly difficult to operate, the solution must ensure absolute data integrity for data in transit (e.g., messages), data at rest, and software.

### SUMMARY

An example embodiment of the present invention is directed to a method executed by one or more computing devices for encoding data to be transmitted from sender to receiver over a distributed network. In the method, an original data record to be transmitted by the sender to the receiver is fractionalized into fractionalized shards. Each fractionalized shard contains at least a portion of the data in the original data record. The method includes then encrypting each of the fractionalized shards, each encrypted shard including encoded data of the original data record, and then subjecting each encrypted shard to polar coding so as to generate a plurality of indistinguishable and independent polarized tokens. Each of the polarized tokens are then dispersed using superimposed coding to create a plurality of holographic tokens for transmission, with the holographic tokens being collectively representative of the encoded data of the original data record.

Another example embodiment is directed to a computer system adapted for encoding data to be transmitted from sender to receiver over a distributed network. The system has a processing hardware set and aa computer-readable storage device medium. The processing hardware set is structured, connected and/or programmed to run program instructions stored on the computer-readable storage medium instructions and associated data. The program instructions include at least a user module programmed to accept an original data record of the sender for transmission to the receiver, and to fractionalize the original data record into a plurality of fractionalized shards, each fractionalized shard containing at least a portion of the data in the original data record, and a symmetric cryptographic module programmed to encrypt each of the fractionalized shards, each encrypted shard including encoded data of the original data record. The program instructions further include an error correction module programmed to subject each encrypted shard to polar coding so as to generate a plurality of indistinguishable and independent polarized tokens, and a resilience module programmed to disperse each of the polarized tokens using superimposed coding to create a plurality of holographic tokens for transmission, the holographic tokens collectively representative of the encoded data of the original data record.

Another example embodiment is directed to a method of assuring integrity of data transmission between a sender and receiver in a communication system. The method includes fractionalizing original data from the sender into fractionalized shards, each fractionalized shard containing at least a portion of the data in the original data record. Each fractionalized shard is then broken into an indistinguishable polarized token by generating a private shard key for each fractionalized shard, encrypting each shard, and then encapsulating essential information of the encrypted shard, the essential information representing at least a portion of the data in the original data record, into polarized independent tokens using polar-coding. The polarized tokens are then dispersed using a distributed parity model randomly generating superimposed codes to thereby create a plurality of holographic tokens. The method further includes randomly spreading the plurality of holographic tokens out across nodes of the communication system upon transmission and, upon arrival of the holographic tokens at the nodes, intermixing each of the plurality of holographic tokens at the nodes with other holographic tokens via entanglement to homogenize identities of the holographic tokens such that the holographic tokens become hidden.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a high-level flow diagram to describe a method of encoding data transmitted from a sender to a receiver according to the example embodiments

FIG. 2 is a diagram to illustrate in general the concept of creating a Q-Token from a shard according to an example embodiment.

FIG. 3 is a block diagram to illustrate a system for implementing the method of encoding data transmitted from sender to receiver across a communication system such as a distributed network.

FIG. 4 is a Venn diagram to help further illustrate the concept of entanglement.

FIG. 5 is a block diagram similar to the system figure of FIG. 3 but showing additional architecture behind the method of encoding in more detail.

FIG. 6 is an illustration to help understand the augmented cryptographic witnessing protocol according to the example embodiments.

FIG. 7 is a diagram to illustrate the Q-Token coding structure.

FIG. 8 is an illustration to assist with explaining how data encoding works to produce the holographic token (Q-Token).

FIG. 9 illustrates a graphic use case for the applied method and system of encoding for transmission described herein.

FIG. 10 is a graph describing data availability in adversarial environments during network outages to better demonstrate features of data integrity.

FIG. 11 is a block diagram of an exemplary computing device to drive system so as to implement the example method according to the example embodiments.

### DETAILED DESCRIPTION

The example embodiments hereafter describe in general, a system and one or more methods adapted for encoding data over a distributed network using principles of fractional tokenization of original data (in motion or at rest) to be transmitted. Namely, the example methodologies incorporate fractional encoding of slices of the original data (“encrypted shards”), with principals of polar coding and superimposed coding (also known or referred to as “superpositioning”, “multiplex superpositioning” or “superimposed concurrent coding”) to create a holographic token for each shard, and principles of entanglement to mix the created holographic token with others upon dispersal across the network. Occasionally hereafter for purposes of brevity and identity a holographic token created from a shard is referred to as a “Q-Token”.

The example embodiments also describe a method of providing secure communications across a distributed network based on the principles above, or more specifically a method of assuring integrity of data transmission between a sender and receiver in a communication system. This may be done namely through the introduction of a new code where original data from a transmitter/transmit source is to be encoded utilizing holographic principles as described hereafter. The original data to be transmitted across the distributed network is subject to a fractionalized tokenization in which the original data is fractionalized through an initial encryption process into encrypted shards, which are then tokenized via both polar coding and superimposed coding into holographic tokens (Q-Tokens). The holographic tokens may then be entangled in such a way after being transmitted via blockchain records to nodes of the network for access by a receiver, such that the holographic tokens can be reconstructed back into the now decoded shards which are reassembled so as to restore the original data sent by the transmitter to the receiver.

The example system is designed to leverage storage and bandwidth resources efficiently by exploiting the combinatorial power of networks and their concomitant reliability. The example method functions of creating new distributed encoded data based on encoding which relies on holographic principles, sharding, aggregation, and reconstruction offers a resource efficient and real-time design based on virtual subnetworks overlaid to physical networks in representing entangled data that yields a scalable and high data integrity solution to accommodate future requirements.

The system and methods are also designed so as to prevent the encoded data from being cloned, since the encoded data exists in a distributed form over the network. Hence, the intrinsic identity and integrity of the encoded data is preserved through any and all network operations, disruptions, or catastrophes.

In contrast to existing solutions that tokenize assets non-compositionally onto a blockchain, the example embodiments described in more detail hereafter encapsulate compositional transformation in the production process and onto the blockchain ledger. The result is a set of smart contracts in the system that handle composable assets by capturing their creation, transformation, and exchange on a distributed ledger while remaining resistant to tampering, fragility, degradation, hacking, and corruption. As will be shown hereafter, these smart contracts (as part of a smart contract subsystem) automate the entire example methodologies described herein, which may be implemented by a computing system or computer core known as a Distributed Ledger Virtual Machine (“DLVM” or “DVLM core”). In an addition to automation, these smart contracts enable network policies to be followed and satisfied on the DLVM.

The to-be-described Q-Token is extremely resilient to degradation or loss. Testing has shown that perfect reconstructive decoding can be achieved and proven even when the signal to noise ratio is 85% noise (for example, on a 100 dB signal scale, Applicants could still recover at 15 dB) in the case of weak signal transmission and, furthermore, even when there are contiguous blocks of 60% of the transmission is missing. Applicants' process was demonstrated to be 50% more efficient in terms of power requirements than other competing cyclic codes or schemes due to the high compression achieved by both the superposition and holography.

Several features of the holographic tokens (Q-Tokens) described hereafter offer a desirable benefit and emerge in particular for distributed data keys, distributed tokens, blockchain systems and especially, high integrity data proofs at reduced costs. For example, in blockchain systems, banking and financial data systems, or privacy preserving distributed data systems, a key criteria is to enable auditability with privacy. Today, current systems require the public to produce an audit, which can lead to vulnerability in privacy.

In contrast, Applicants' system is a fully auditable, unconditionally anonymous blind system (or where used in other systems requiring anonymity if that is the user's intent), or to provide fully auditable publicly verifiable immutable records for accounting. Therefore, the example system does not enable blackmailing, cyber robbery, and/or bad behavior because each transaction, while anonymous and auditable, has a holographic cryptographic record chain so that attribution when or if needed can be proven. This has a benefit to the performance of smart-contracts as well as a significant step towards practicality since, unlike prior art systems, the example methods and system do not depend on protocols for zero knowledge proofs. Secondly, the cost of any attached payment protocol using this token will be independent of the number of total coins withdrawn since concurrent transactions can be superposed and decomposed as needed during transmission.

Further, Applicants' Q-Token as a unique formulation of superimposed concurrent coding provides a superior solution to clock recovery and synchronization in peer-to-peer (P2P) blockchain communication.

Network systems use mapping algorithms to locate nodes according to one of three main types: table-based, rule-based and random (pseudorandom) distributions. Given that data resides or is placed at nodes in the network and that very little is known about how placement policies affect the network behavior, the use of the Q-Token as described hereafter solves this by enabling fractional data distribution (i.e. placement). In this sense, Q-Token combines two quantum inspired concepts of superpositioning (superimposed coding) and entanglement: entanglement relates a byte-array and a datum, via distributed placement, into a one-to-many relationship, i.e., one byte-array is part of many data. Superpositioning enables redundant information overlaps across a network and provide multiple paths to recover unavailable content.

Applicants' Q-Token has three features of note: (a) Q-Token entanglement: if Q-Token Ti depends on Q-Token Tj, then whenever Tj cannot be recovered, neither can Ti; (b) Q-Token superpositioning: whenever Ti is superposed with Tj in Tk then either Ti or Tj is recoverable from Tk; and (c) Q-Token All-or-Nothing Integrity: the system provides maximum achievable dependency between any three arbitrary tokens, Tx, Ty, and Tk.

Accordingly, the currently emerging blockchain networks can grow to include thousands and more likely millions of nodes in each network. Data integrity becomes critical for consensus to effectively function. For example, with sensors or cryptocurrencies, the usual reliance on symmetric key management has been traditionally used in embedding integrity with confidentiality and, therefore, the distribution problem grows to quickly pose a major barrier to being able to scale the networks to the required size. However, if no secret keys are used at all, and integrity is managed separately from confidentiality, then key management performance barriers for large blockchain networks becomes tractable. The development of asymmetric cryptography, with public-private keys for confidentiality, still relies on the data being in integrity in the first place. No one has yet devised a means of using asymmetric keys as a means for providing integrity to data which is one of the innovations herein.

As to be shown hereafter, the system and methods herein offer the following benefits in providing high integrity data, including but not limited to: covert encoding, decoding and transmission, network and data are through cryptographic witness to guarantee integrity, fault tolerance, error correction is Anti-Fragile, censorship resistant, DDoS resistant, zero downtime, self-sustaining, bandwidth efficient, and real-time.

In the following description, certain specific details are set forth in order to provide a thorough understanding of various example embodiments of the disclosure. However, one skilled in the art will understand that the disclosure may be practiced without these specific details. In other instances, well-known structures associated with manufacturing techniques have not been described in detail to avoid unnecessarily obscuring the descriptions of the example embodiments of the present disclosure.

For the purposes of this disclosure, the phrase “data transmission” or “transmission”, where used, is defined as the physical transfer, via software, of digital data over a point-to-point or point-to-multipoint communications channel. As used herein, the phrase “assured data transmission”, also referred to by the phrase “Proof of Data Integrity” or “PoDI” references a method to assure data transmission between sender and receiver. For purposes of this disclosure, the phrase “data integrity” means the maintenance, assurance of accuracy, and consistency of data.

As used herein, the term “antifragility” refers to a property of communication systems that increase in capability to thrive as a result of stressors, shocks, volatility, noise, mistakes, faults, attacks, or failures.

For purposes of this disclosure, a distributed ledger is a consensus of replicated, shared, and synchronized digital data geographically spread across multiple sites, countries, or institutions. In the context of this disclosure, blockchain is a record-keeping technology designed to make it impossible to hack the system or forge the data stored on it, thereby making it secure and immutable. It is a type of distributed ledger technology (DLT), a digital system for recording transactions and related data in multiple places at the same time. Blockchain is the core technology for cryptocurrencies like bitcoin. Thus, a blockchain ensures the integrity of a cryptocurrency by encrypting, validating, and permanently recording transactions.

Data provenance, referred to hereafter as “provenance” is the field of recording the history of data, from its inception to various stages of the data lifecycle. Thus, provenance helps provide a detailed picture of how the data was collected, where it was stored and how it was used. This record essentially forms an audit trail for the data itself. In the context of a blockchain, provenance enables an entity to easily collate their data, along with open data, and also to verify key information (e.g., is this product organic?) on the blockchain, which holds the most important information and allows anyone to check its validity.

Where used herein, the term “fractionalizing” refers to a process of randomly slicing a data file (or data record) into multiple data files (each a “shard of data” synonymous with and referred to occasionally hereafter as a “shard” or data “shard”, and transmitting the shards across multiple digital machines (e.g. network nodes).

For this disclosure, the phrase “smart contract” defines a set of instructions used by distributed ledger network nodes (digital machines) to execute a specified consensus truth method (such as a third-party execution with a central authority), represented herein as the execution of a PoDI process. The smart contracts herein automate processes of the example methods and system.

“Fractional tokenization” as used in this disclosure means the chopping up of the original data for transmission (“fractionalizing”) into pieces (shards), each representing a fractional piece or slice of the original data. Namely, the original data is being fractionally tokenized by first fractionalizing the original data into shards which are then subject to encoding by encryption, then polar coding the encrypted shards to be transformed into polarized tokens, and then subject to dispersal via superimposed coding so that the polarized tokens are transformed into holographic tokens to be transmitted via blockchain records to various nodes of the distributed network.

As the original data is being fractionally tokenized, an identity is being allocated to the token, that is, the token now knows to whom (or what entity) it belongs. Thus the tokens realized from fractional tokenization are fundamentally a medium of exchange (allocation of identity), unlike simple data shards which are simply an instance that has no identity or value system attributed to it. This essentially represents the creation of a private governance agreement or contract. But instead of being an implicit contract, it is made explicit, which enables proof that between any person or sensor and the system, there is always an agreement. That agreement is the smart contract as defined above.

In the context of this disclosure, a “cryptographic receipt” or “PoDI cryptographic receipt” is a data sent receipt consisting of all the hashes of the shards of the original data combined with the distributed ledger network node structure. Namely each shard gets its own shard key that is XOR'ed with the portion of the original data in the shard so as to destroy its content identity. The shard key of each shard is gathered into the created PoDI cryptographic receipt.

As used herein “polar coding” in general refers to a multiple recursive concatenation of a short kernel code which transforms a physical channel into virtual outer channels. A “data hologram” denotes where each shard of data includes all of the original data to be transmitted prior to fractionalizing the original data into shards. Additionally, a “data meld” means the entanglement of distributed ledger network node data with the sender's superposed data hologram. Further, “superpositioning” represents the encoding of a data hologram with binary code; also referred to herein as superimposed coding.

In this disclosure, a “Q-Token” defines a holographic token created for an encrypted shard from the original data to be transmitted that has had its essential information encapsulated into independent polarized tokens using polar coding, with the polarized tokens being further dispersed via application of randomly generated superimposed codes so as to create the Q-Token.

For purposes of this disclosure, “D5” means Degradation, Deception, Delay, Disruption and Destruction of data. “Degradation” is the denial of access to a level specified and represented as a percentage of capacity, timeliness and/or quality. “Deception” means an attempt to misled by manipulating data. “Delay” means to increase latency (period of time) in transmission of data. “Disruption” is the complete but temporary denial of access to, or operation of, a target for a period of time. A desired start and stop time are normally specified. Disruption can be considered a special case of degradation where the degradation level selected is 100 percent. “Destruction of data” is the permanent, complete, and irreparable denial (time and amount are both maximized) of access to data. Additionally, to “deny” is to degrade, disrupt, or destroy access to, operation of, or availability by a specified level for a specified time; denial prevents use of.

As used herein, the phrase “Key Performance Indicator” or “KPI” is a critical performance metric that when met ensures mission success (e.g., operationally effective or suitable). A “KPI Objective (0)” represents value-added operational performance of a deployed system, application, and/or service; additionally a “KPI Threshold (T)” represents minimum acceptable operational performance of a deployed system, application, and/or service. Further, the phrase “Key System Attribute” means an important attribute of a system, application, and/or service that when achieved ensures that one or more KPI(s) can be achieved.

“Public Key Infrastructure” or “PKI” is defined as the roles, policies, hardware, software and procedures needed to create, manage, distribute, use, store, and revoke digital certificated and managed public-key encryption. Further, in the context of this disclosure, the term “resilience” is in the context of resilience in cyberspace, and is defined as the ability to adapt to changing conditions and prepare for, withstand, and rapidly recover from a D5 perspective.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one example embodiment” or “an embodiment” means that a particular feature, structure or characteristic described in connection with the embodiment is included in at least one embodiment. Thus, the appearances of the phrases “in one example embodiment” or “in an embodiment” in various places throughout this specification are not necessarily all referring to the same embodiment. Further, the particular features, structures or characteristics may be combined in any suitable manner in one or more example embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

As used in the specification and appended claims, the terms “correspond,” “corresponds,” and “corresponding” are intended to describe a ratio of or a similarity between referenced objects. The use of “correspond” or one of its forms should not be construed to mean the exact shape or size. In the drawings, identical reference numbers identify similar elements or acts. The size and relative positions of elements in the drawings are not necessarily drawn to scale.

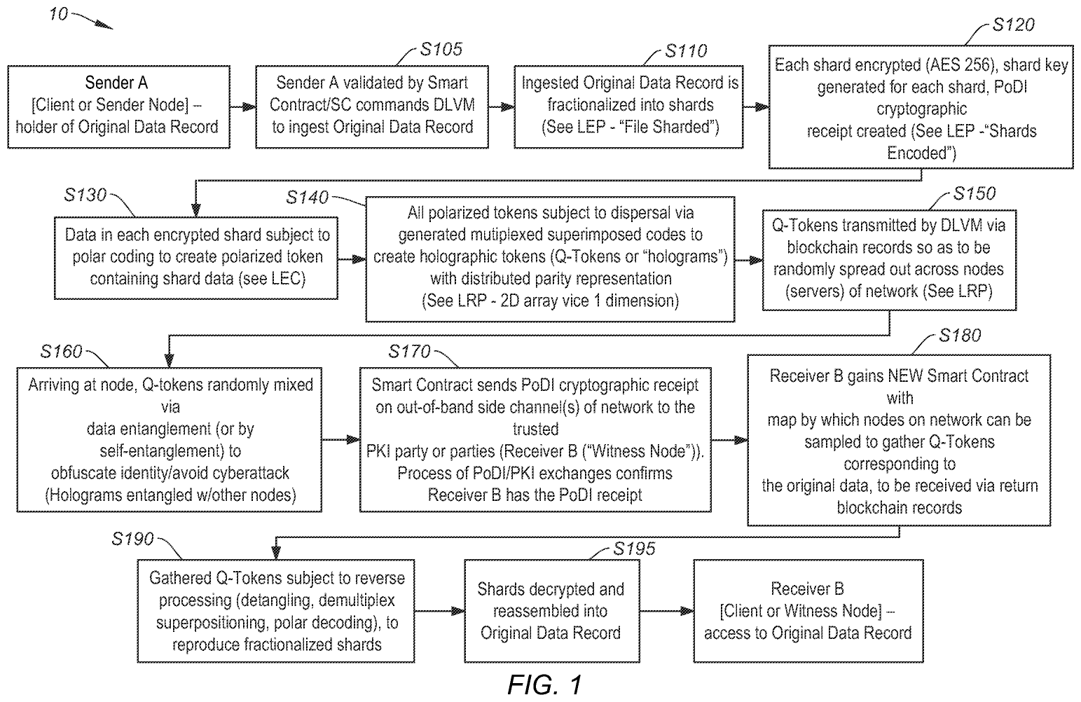

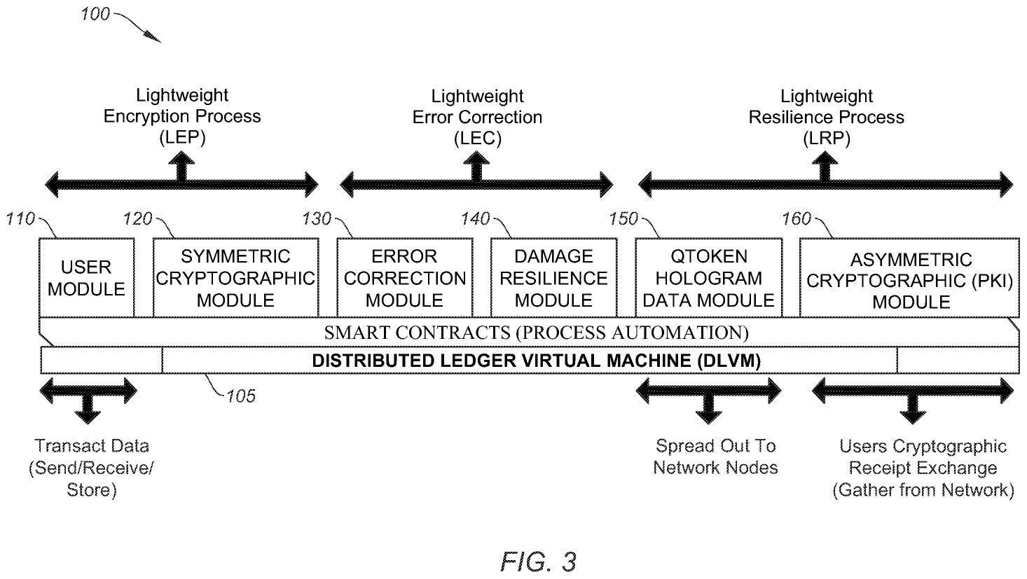

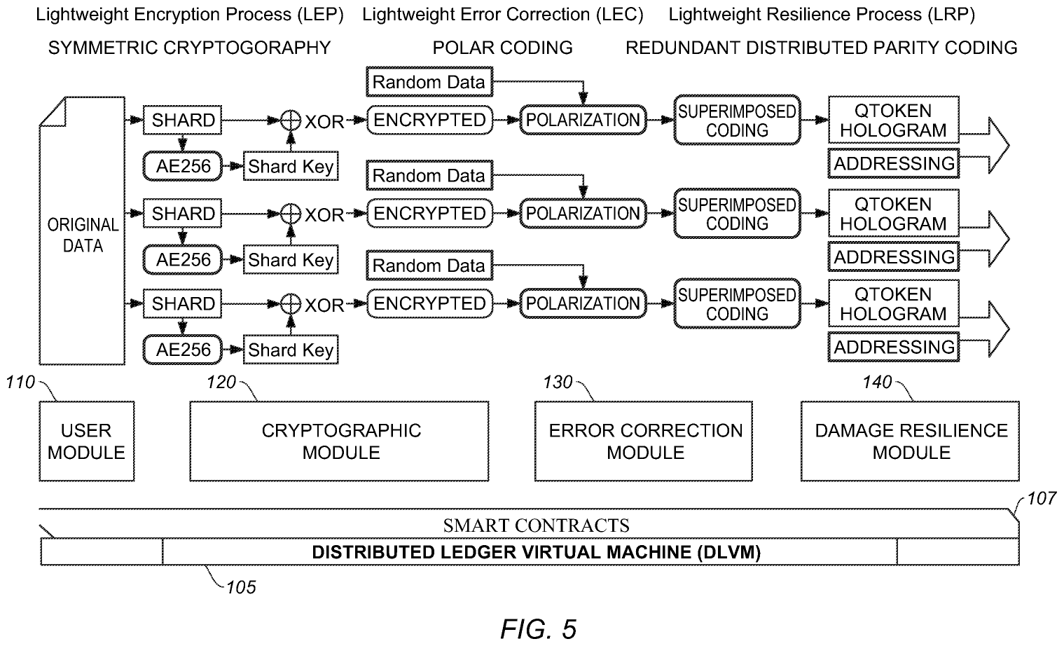

FIG. 1 is a high-level flow diagram to describe a method of encoding data transmitted from a sender to a receiver according to the example embodiments. For the following discussion, occasional reference should also be made to FIG. 3, which shows a block diagram of a system to implement the above-noted method. Additionally, reference should be made to FIG. 5, which provides additional architecture behind the method and system of encoding with more detail in order to enhance the understanding of the inventive method and system according to the example embodiments.

In general, FIG. 1 depicts the flow of data from a Sender A to a Receiver B according to the example methodology. The process involves the transmission and receipt of a smart contract, along with multiplexing and demultiplexing of data through a distributed ledger, the DLVM.

Sender A has some type of communication data (“original data record”) (such as data in motion or data at rest) that it desires to transmit from its client (smart computing device with software) across a distributed network to be received by a client of a Receiver B. Accordingly in the method 10, Sender A sends some kind of data record, such as a photo, message, or video to intended recipient Receiver B.

Before any processing can be done, a smart contract, which automates the processing and ensures policies within the DVLM are satisfied) validates Sender A and ensures policies are met. The smart contract then commands the DLVM core to ingest the original data record (S105) in preparation for transmission. The DLVM core is the node (server) that executes the network function virtualization logic in the smart contract and handles the orchestration and low-level details of IPV4 and IPV6 communications.

The original data record ingested by the DLVM is fractionized into shards (i.e., sliced into chunks of the original data record (S110). At S120, each shard is encrypted using a fast encryption process that also generates a private key for each shard. A Proof of Data Integrity (PoDI) cryptographic receipt (or “PoDI receipt”) is also created. Each shard gets its own shard key that is XOR'ed with the portion of the original data in the shard so as to destroy its content identity. The shard key of each shard is gathered into the created PoDI cryptographic receipt.

For each encrypted shard, the data therein is subject to polar coding (S130). For example, polar coding is used as a linear block error-correcting code employing a Feistel PRNG (Pseudo-Random Number Generator) via XOR (reversible operator). Each polarized token is then subject to dispersal via randomly generated multiplex superimposed codes (S140) to create holographic tokens, specifically the Q-Tokens. For example, superimposed coding (aka concurrent coding) is used to transform each linear polarized token into a Q-Token with a redundant array structure, having a distributed parity representation (2D array vice 1 dimensional string). Namely, a deep resilience process discussed in more detail hereafter employs the aforementioned superimposed coding to disperse the polarized tokens into a sparse data coefficient structure of the resultant Q-Tokens that can losslessly reconstruct data even if most of the coefficients are damaged. This is possible because each coefficient has knowledge of other coefficients to produce the Q-Token, a distributed parity representation. Parity and redundancy are thus distributed along 2-dimensions instead of 1-dimension using a space-filling-curve.

The Q-Tokens are then transmitted by the DLVM via blockchain records (S150) so as to be redundantly spread out into a network, which is to say, redistributed randomly to DLVM nodes on a larger network, which in an example could be a multi-cloud of DLVMs. Particularly, as the Q-Tokens arrive at their DLVM nodes, they are intermixed with other Q-Tokens via entanglement (or self-entanglement) (S160) so that their identities are homogenized. At the nodes, these Q-Tokens become hidden.

Meanwhile, the smart contract has created an out-of-band secret side channel that itself can dynamically vary so that there is no single attack point. The smart contract sends the created PoDI cryptographic receipt on this out-of-band side channel(s), to the trusted party or parties (Receiver B) (S170). This works by generating several One Time Pad (OTP) private keys for the public key infrastructure (PM) process of exchanges to the recipient on each channel, here the recipient being Receiver B. A OTP is an encryption technique that cannot be cracked, but requires use of a single-use pre-shared key that is no smaller than the original data record being sent. In this technique, a plaintext is typically paired with a random secret key (also referred to as a one-time pad). Through the process of PoDI/PKI exchanges and authentication, Receiver B is confirmed as a trusted party by the smart contract.

PKI and management by the smart contract ensures that only the intended recipients or transmitters can send or receive data on the example system 100 described hereafter as the sender and receiver exchange PoDI cryptographic receipts. As noted below, each PoDI receipt represents a map of the dispersed parts and locations of Q-Tokens on nodes of the network. Since these Q-Tokens (like many jigsaw puzzles) are all mixed up together, there is no way to regain data if the PoDI receipt is lost—a re-transmittal must occur.

At S180, once this process is complete, the recipient (Receiver B) gains a new smart contract, namely a DLVM map to the Q-Tokens dispersed across the nodes (the key of which is the aforementioned PoDI cryptographic receipt). Thus, this map provides a way by which the nodes on the distributed network can be sampled in order to retrieve the candidate recalled Q-Tokens to be gathered, these Q-Tokens corresponding to the original data record.

At this point, the new smart contract's process automation thus recalls all Q-Tokens from the network nodes. In general, the recalled and gathered Q-Tokens are simply reversed through a process (which includes detangling, demultiplex superpositioning (or superimposed decoding) and polar decoding to reproduce the encrypted, sharded data, which in turn are decrypted and then reassembled into the original data record. As such, the collected Q-Tokens are subject to a “reverse processing” at S190 (e.g., detangling, demultiplex superposition/superimposed decoding, polar decoding) to reproduce the encrypted shards. The encrypted shards are then decrypted as the originally fractionalized shards that are then reassembled (S195) into the original data record for access by Receiver B.

Although not shown, the original data record is either proven or disproven to have perfect integrity. Namely, the SHA256 hash is recomputed and compared to the original, and if they match then the Proof of Integrity is satisfied, otherwise an alert is provided to the user (Sender and/or Receiver). Alerts may be provided to both sender and receiver if there is bit damage (green alert) or if there is an unrecoverable loss of integrity (red alert). Alerts can also determine quantity, where and how damage occurred.

Accordingly, as shown in FIG. 1, in the example method and system original data can be fractionalized into shards that may be broken down into indistinguishable tokens by generating a private key for each shard, encrypting the shard, and then encapsulating the shard's essential information into polarized independent tokens using polar-coding. The polarized tokens are then further dispersed using a distributed parity model randomly generating superimposed codes to thereby create the holographic tokens, e.g., the Q-Tokens, which are then mixed via entanglement and randomly dispersed across the distributed network. Of note, the holographic tokens that collectively represent the encoded data of the original data record cannot be cloned.

The method 10 of FIG. 1 can be viewed in another context as representing a method of assuring integrity of data transmission between Sender A and Receiver B in a communication system. In such a method, original data from Sender A is fractionalized into fractionalized shards, with each fractionalized shard containing at least a portion of the data in the original data record. Each fractionalized shard is then broken into an indistinguishable polarized token by generating a private shard key for each fractionalized shard, encrypting each shard using the shard key, and then encapsulating essential information of the encrypted shard into polarized independent tokens using polar-coding. The essential information represents at least a portion of the data in the original data record.

Upon the smart contract conducting key exchanges with a trusted part (such as Receiver B) and the Receiver B being validated so as to receive the PoDI cryptographic receipt, Receiver B uses a map from the PoDI receipt to gather the Q-Tokens of interest for reverse processing into the original data record.

The encoding process outlined in FIGS. 1 at S120 to S140 creates holographic tokens (Q-Tokens) that are randomly dispersed onto nodes of a distributed network with conditions for persistence, such as, life expectancy (i.e., how long they reside at rest in the network before automatic dissolution). A malicious examination of any randomized, individual Q-Token offers at least the following hurdles to an attacker: (a) no ability to identify Q-Token owner or its source, (b) no ability to decode the Q-Token content via any kind of deep content inspection, and (c) no ability to re-assemble the original data record (whether the data is in motion or at rest).

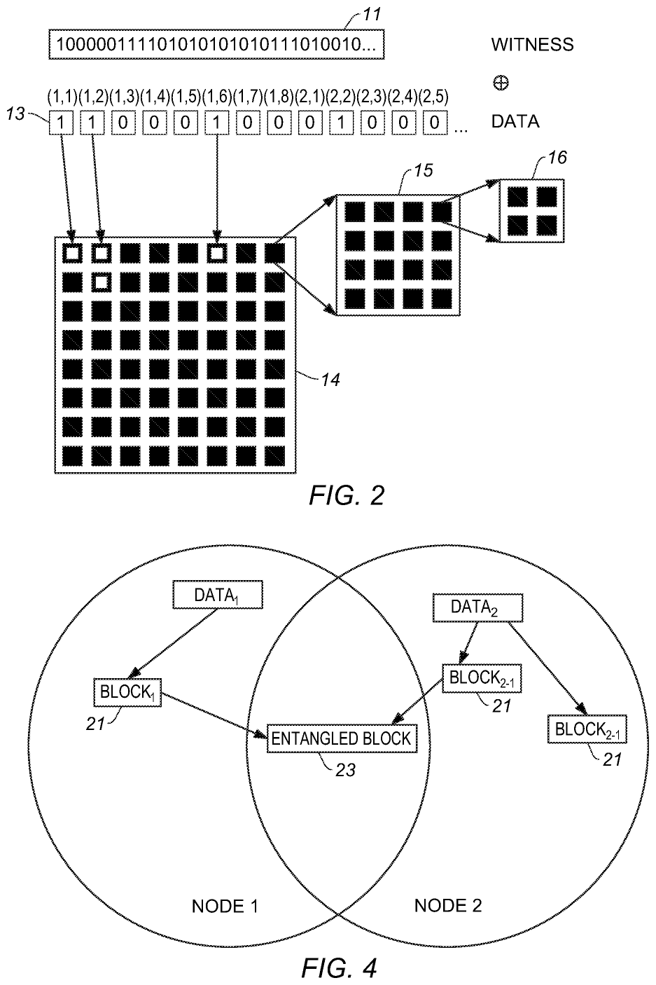

FIG. 2 is a diagram to illustrate in general the concept of creating a Q-Token from a shard according to an example embodiment. Namely, this is a diagram to aid in explanation of the fractionalization behind holographic encoding so as to arrive at the Q-Token. As shown in FIG. 2, the original data record is recorded as bits of data, ones and zeros, shown and referred to as the Witness 11. The ones and zeros within the Witness 11 are represented as 1-dimensional data 13 of the original data record. A 2-dimensional array (the 8×8 bit shard 14, containing some portion of the original data 13) presents these ones and zeros as either a bright white cell (for ones) and 4×4 Q-Token 15, a single cell of which in turn is yet further fractionalized into a 2>2 Q-Token 16.

FIG. 3 is a block diagram to illustrate a system for implementing the method of encoding data transmitted from sender to receiver across a communication system such as a distributed network. Namely, FIG. 3 shows a system 100 which includes the DLVM core 105, the six (6) major functional modules (modules 110 to 160) of the system 100, and a smart-contract subsystem 107 underlying the modules 110-160 and designed to manage all data exchanges with trusted parties which automates the entire example method 10 and enables network policies on DLVM core 105. The six major functional modules 110-160 represent lightweight, real-time, edge-embeddable processing for all data handled between the user module 110 to the Asymmetric Cryptographic Public Key Infrastructure (PKI) module 160.

In its method of encoding, system 100, through its DLVM 105 core, the smart contracts subsystem 107 and the six modules, implement three subroutines that make up the bulk of method 10 as described in FIG. 1. These are termed (a) a Lightweight Encryption Process (LEP), (b) a Lightweight Error Correction (LEC) subprocess, and (c) a Lightweight Resilience Process (LRP) subroutine. The LEP subroutines in part require both a User Module 110 and a Symmetric Cryptographic Module 120 to perform various functions, routines and tasks. Namely, the User Module 110 is employed for setting up the system configuration as part of the LEP subroutine, specifically for sending, receiving, storing, or applying policies to data in motion and/or at rest, with the cryptographic SHA256 Hash function of the original data record being calculated as proof. The User Module 110 accepts sender data for transmission (such as the original data record described in FIG. 1) and, based on user-configurations, fractionalizes this data into shards for processing, as outlined in S110 of FIG. 1. There is provided an option for creation of equal length shards, random-length shards, or no shards, with the created PoDI Cryptographic Receipt outlined in step S120 in FIG. 1 transcoded in the same way as the original data record.

The LEP subroutine requires performance of the Symmetric Cryptographic Module 120. This module 120 is what encrypts the shards. This is done with a Fast Encryption Process (FEP), specifically using fast symmetric built-ins, e.g., AES-256 FIPS-140 encryption, and the keys to the PoDI cryptographic receipt. The Symmetric Cryptographic Module 120 provides each shard an individual shard key that is XOR'ed with the original data. This permits the destruction of its content identity. The shard key is then gathered into the PoDI cryptographic receipt. This allows the symmetric shard key to function as a private-key, if PKI security is needed as an additional layer of security for ultra-sensitive long-term storage.

The Lightweight Error Correction (LEC) functionality is iterated in part through an Error Correction Module 130, where Polar Coding is used as a linear block error-correcting code incorporating a Feistel Pseudo-Random Number Generator (PRNG) via XOR (a reversible operator) function. Each encrypted shard is polarized with seed setting for initiation of the random number sequence, along with the Feistel net encrypted with AES-256 to PoDI to correct any errors that enter through the downstream hologram (the downstream hologram understood as the to-be-created holographic tokens or Q-Tokens). The duplication of shards is done by using an extra bit in the Feistel code, e.g., if the shard is 1024 bits, then create a 2048-bit sequence and XOR the data redundantly.

The LEC subroutine also requires a Damage Resilience Module 140 that uses superimposed coding (also known as concurrent coding) to transform each linear polarized token into a redundant 2D array structure that represents the holographic token or Q-Token. Parity and redundancy are thus distributed along 2-dimensions instead of 1-dimension using a space-filling-curve. A space-filling curve is well known in mathematics as a way of mapping a multi-dimensional space into a one-dimensional space. It acts like a thread that passes through every cell element in the multi-dimensional space so that every cell is visited exactly once. Alternately, the space-filling curve can be omitted and the superimposed coded hologram can be sent as the Q-Token for subsequent spreading out of Q-Tokens across nodes of the network in the LRP subroutines, and follow-on entangling with other Q-Tokens upon its arrival at select nodes, data entangling described below as part of the LRP subroutines.

The Lightweight Resilience Process (LRP) subroutines accommodate a Q-Token Hologram Data Module 150. With reference to FIGS. 1 at S150 and S160 of method 10, module 150 in general is designed to randomly spread the Q-Tokens out across the nodes of the network (see FIG. 1 at S150) upon transmission of the Q-Tokens to the nodes (via blockchain records), namely for the Q-Tokens to be redistributed randomly to DLVM nodes of the network. As the Q-Tokens arrive at their DLVM nodes, the Q-Token Hologram Data Module 150 directs intermixing with other Q-Tokens via entanglement (or self-entanglement) (S160) so that their identities are homogenized. At the nodes of the network, these Q-Tokens are hidden.

In general, entanglement codes create redundancy by tangling new data blocks with old ones, building entangled data chains that are woven into a growing mesh of interdependent content. The output of entanglement codes is obtained by encoding the input with previously encoded data that could be retrieved from different and remote storage locations or obtained from the state of the encoder register. Entanglement codes can encode a stream of bits as well as blocks. Integrity guarantees are proofs that no data is lost or tampered with regardless of the confidentiality. As to be shown hereafter by Venn diagram, the present system 100 splits byte-streams (shard with data) into blocks (Q-Tokens) n such a way that a single block can become part of several data, hence an entangled block. The entangled block thus is able to resist identification.

Entanglement codes can create resilience by tangling new data blocks with old ones, creating sub-networks of entangled data that are combined into a mesh. The elements that form this mesh can be mapped to storage locations in a one-to-one or a many-to-many relationship, in such a way that integrity through redundancy is continuously propagated across the system as new information is ingested by the system. The coding technique mechanism used for data entanglement is lightweight and efficient, essentially based on exclusive-or operations.

Referring again back to FIG. 3, additionally the Q-Token Hologram Data Module 150 can be embedded with random padding to make constant length datagram packets for the Q-Tokens. Padding can be understood as bits or characters that fill up unused portions of a data structure, such as a field, packet or frame. Typically, padding is done at the end of the structure to fill it up with data, with the padding usually consisting of a single bit, blank characters or null characters. Padding is omitted if speed and real-time is most important or kept for highest anti-content spoofing.

These datagram packets of Q-Tokens are distributed onto the network with locations of the spreads encrypted in the PoDI receipt, where each set of K random number pads (user or auto set) is encoded into a single number and added to the PoDI receipt using the bijective Cantor Pairing/Unpairing function. The PoDI receipt thus forms the map as previously described to access and receive the intended Q-Tokens and associated data. This allows all Q-Tokens to be XOR'ed at the nodes of the network using the PoDI receipt as a data entanglement.

FIG. 4 is a Venn diagram to help further illustrate the concept of entanglement. In particular, the illustration of FIG. 4 shows and example of two user or ledger peer overlays of a Venn, so as to help explain PDP distributed entanglement between two separate ledges (user accounts). Referring to FIG. 4, two NODE environments are shown in separate but intersecting circles, NODE 1 represents a ledger and user account for a first user; NODE 2 represents a ledger and user account for a second user. DATA within each NODE (DATA₁ and DATA₂) represents a shard. Each BLOCK of the shard (see BLOCK₁, BLOCK₂₋₁, BLOCK₂₋₂) represents Q-Tokens (or “holograms”) not entangled (see BLOCKS 21). In particular, Q-Tokens from both ledgers that are entangled are as shown by ENTANGLED BLOCK 23. Also note that that it is possible to entangle an entirely different ledger other than the two show here. The hologram of the other ledger (BLOCK₂₋₂ of NODE 2) is actually entangled elsewhere in FIG. 4. The entangled data resists identification.

Accordingly, the Venn diagram of FIG. 4 described P2P distributed entanglement according to the example embodiments. Features resulting from such may include enhanced ledger persistence and anti-fragility, anti-censorship properties, as well as anti-tampering effects.

Referring once again back to FIG. 3, the LRP subroutine further accommodates an Asymmetric Cryptography Module 160. Module 160 is where the Public Key Infrastructure (PKI) is used to exchange the PoDI receipt to a trusted authenticated (PKI) end user, as first noted in FIG. 1 at step S170. The PoDI cryptographic receipt is sent on an out-of-band side channel(s) that has been created by the smart contract, to the trusted party or parties (here Receiver B). With a PoDI receipt, the original data can be returned and received by the recipient. The PoDI receipt could also be transcoded into and form the Q-Token representation for added side-channel security.

FIG. 5 is a block diagram similar to the system figure of FIG. 3 but which shows the architecture behind the method of encoding in more detail. As shown, additional detail around the process steps generally recited in FIG. 1 and described in further detail with regard to FIG. 3 are shown. Namely, the original data record (source data) is shown in the LEP subroutine being fractionalized by the Symmetric Cryptographic Module 120 into shards (three shards are shown, it being understood that there could be N shards) the shard keys generated through AES256 hash functions, each key then XOR'ed with its shard data to create the encrypted shard (the processes representing symmetric cryptography).

Next, in the LEC subroutine each encrypted shard is transformed by the Error Correction Module 130 into a polarized token using randomization (e.g., linear block error-correcting code employing a Feistel PRNG (Pseudo-Random Number Generator)), the polarized token subject to superimposed coding in the LRP subroutine to create the Q-Token (holographic token or Q-Token hologram). The Q-Tokens are now ready to be spread out across nodes of the network as they are transmitted via blockchain records for subsequent mixing via data entanglement.

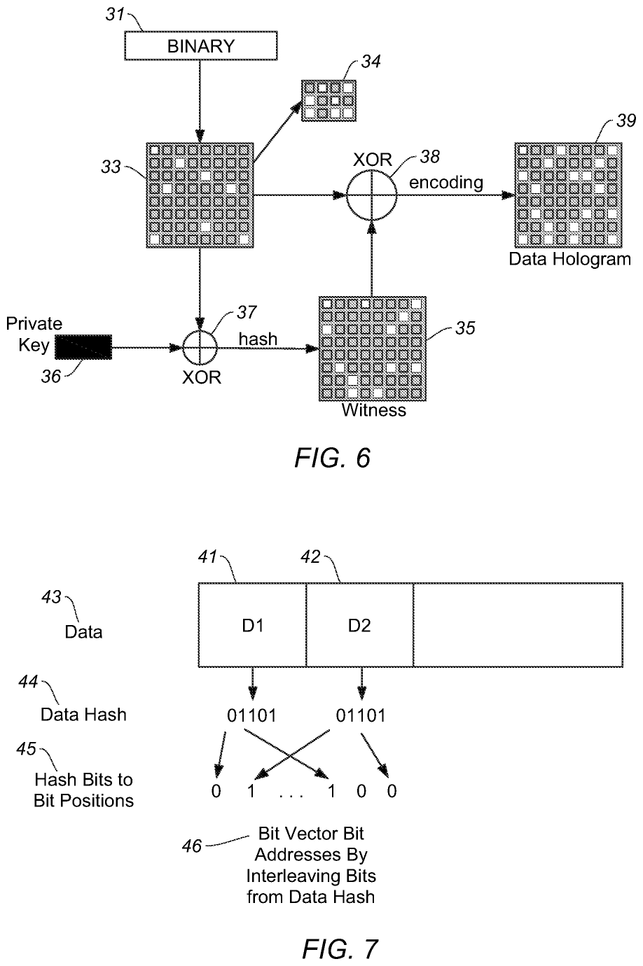

FIG. 6 is an illustration to help understand the augmented cryptographic witnessing protocol according to the example embodiments. System 100 uses artificial intelligence technology in the form of just-in-time compilation of smart contracts. The smart contracts described herein are fundamentally proof-carrying code, i.e., proof carrying data in the form of a PoDI cryptographic receipt that encodes the set of all private keys and subnetwork map for every Q-Token entangled at distributed locations in nodes of the distributed network. The PoDI cryptographic receipt uses cyberspace measurements based on the symmetric distance properties of a XOR operation sent on multiple side channels using FIPS-140 compliant public key infrastructure (PKI) to further mitigate interception probability by a man-in-the-middle attack. As shown in FIG. 6, binary data stored in a shard 31 is further divided into Q-Tokens 33 and 34 via the hash function. The shard is witnessed (at 35) and provided a private key 36 which is XOR'ed (see 37 and 38) and encoded into a holographic data Q-Token (see 39).

FIG. 7 is a diagram to illustrate the Q-Token coding structure. Elements 41 and 42 represent bit locations D1 and D2 on the Q-Token location 43. Five bits are stored in D1, five bits are stored in D2, etc. For illustration purposes five bits are shown, but any number of bits—1 bit, 2 bits, 3 bits, etc.—could be in this Q-Token location 43. A data hash function 44 distributes individual bits to a random bit position 45 not linear in position to another bit. For example, bit 1 may be hashed to position 18, bit 2 may be hashed to position 21, etc. The hash function 44 is a pseudo random (PRNG) hash function that creates a number of bits in different positions so that the code is redundant, i.e., each bit is moved to several redundant bit positions (described at 46). It is one-dimensional data.

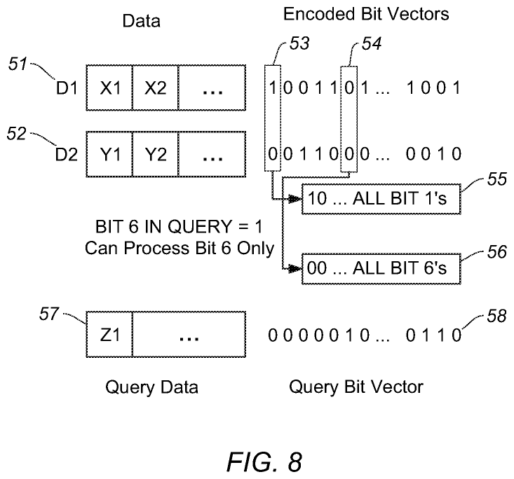

FIG. 8 is an illustration to assist with explaining how data encoding works to produce the holographic token (Q-Token). Q-Tokens integrate the Proof of Data Integrity (PoDI) cryptographic receipt. The Q-Tokens are then distributed (or spread) across nodes of the distributed network to further deter target specific cyber-attacks such as Ransomware. FIG. 8 can help to illustrates how the example methodology, in creating the Q-Token, develops two-dimensional data from one-dimensional data. As shown in FIG. 8, bits of data of a first bit structure 51 are positioned in a linear position (not necessarily adjacent to each other). A separate but equivalent bit structure 52 contains different bits of data. Their juxtaposition creates a linear position of bits of data producing Encoded Bits Vectors 53 and 54, further producing its own bits of data at 55 and 56. The last bits of data at 57 creates an Encoded Bits Vector (shown by element 58) The addition of Encoded Bits Vectors produce a holographic effect offering two ways of looking at the data, either in a line or a column.

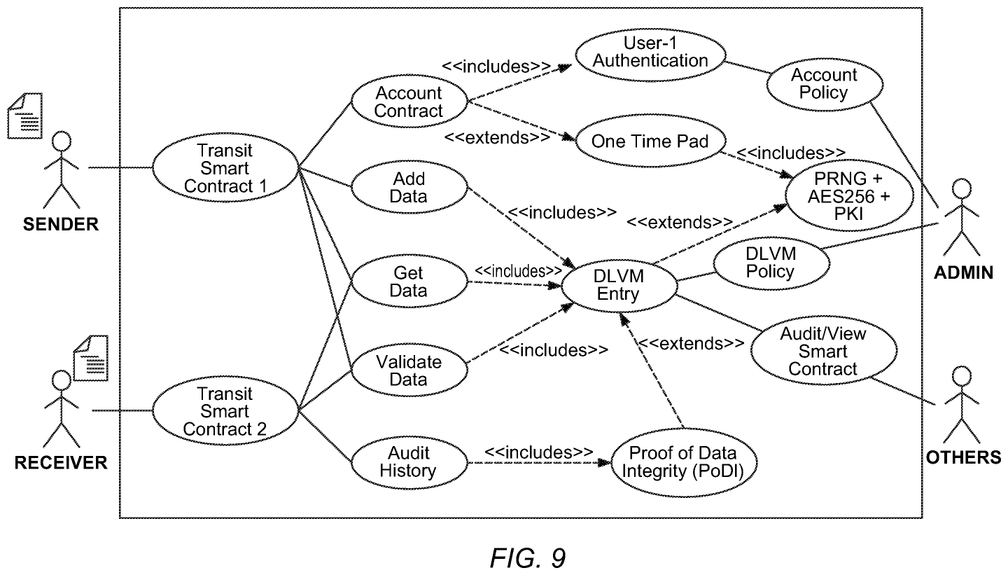

FIG. 9 illustrates a graphic use case for the applied method and system of encoding for transmission described herein. In the graphic, the main system users are persons entering data into a Smart Contract, persons receiving data also in the form of a smart contract, administrators of the system 100, and other required personnel. Access policies for User accounts and the smart contract subsystem required for system 100 operation are managed under procedures set by one or more administrators. Users can only interact with a Smart Contract. This ensures Users have access only per the administrator's procedures. This guarantees non-entry by either inadvertent access or malicious intent. Other than via a smart contract, users never interact with system 100 services directly. In traditional systems, a user could interact with a server or servers housing an application. Per Applicants' design of system 100, user interactions are isolated to a smart contract only. Denying access prohibits the control of the end-to-end processes.

The following TABLE 1 summarizes several features and benefits of a commercial product (trade name DTxLedger™) built out in accordance with system 100. These have become evident as a result of the product designs around the modules 110-160, based on platform use-cases.

Features and Benfits Matrix

| | | | | CERTS & |
|---|---|---|---|---|
| ID | FEATURE | DESCRIPTION | BENEFIT | ACCREDITATIONS |
| 1. | Anti- | Data cannot be | Individuals, | HITRUST, HIPAA, GDPR, |
| | Ransomware | identified, accessed, | corporations, and | NIST NSA, DHS |
| | | changed, held | governments can enjoy | |
| | | ransom by attackers | immunity from cyber | |
| | | | attack | |
| 2. | Security always | Data holograms and | No adversary can | NSA Commercial Solutions for |
| | stays with the | entanglements | target or censure any | Classified Systems |
| | data | | data | |
| 3. | Authorized data | Only authorized | Data bound to identity | NIAP certification of data at rest |
| | usage | users can access | | protection |
| | | their secured data | | |
| 4. | Easy to Deploy | Integrates | Data captured by Man- | ISACA Certified Data Privacy |
| | and Seamless | seamlessly with | In-The-Middle attacks | Certification |
| | | existing IT | at any point in | |
| | | infrastructures | transmission remains | |
| | | | useless. | |
| 5. | Data Shredding | Data is transformed | Irreversible | |
| | | and rendered useless | destruction if needed | |
| | | to unauthorized | for security beyond | |
| | | users | paper-shredding or | |
| | | | disk shredding | |
| 6. | Supports | Critical sensitive | Certificate Authorities | |
| | HIPAA and | data becomes | (CA). Public Key | |
| | PCI-DSS | immune SNDL | Infrastructure (PKI) | |
| | compliance | | becomes immune to | |
| | mandates | | Quantum Attack | |
| 7. | File-level | Holographic bit- | Multi-system, multi- | |
| | encryption | level data | cloud, multi-platform | |
| | | protection, beyond | (IOS, Android, MIPS, | |
| | | the cloud | Windows, Linux, | |
| | | | Raspberry Pi, etc.) | |
| 8 | Management | Configures and | Simple System | |
| | Service | manages keys, user | Management Services | |
| | | authentication, data | | |
| | | licensing, tracking | | |
| | | and audit | | |
| 9. | Secure App | Any data I/O from | Bespoke systems | |
| | Data with the | Android, IOS, | integration | |
| | System 100 | Windows & Linux | | |
| | SDK | is secured | | |
| 10. | Anti-Tampering | Identify the point of | Prosecution and | |
| | Proof | origin of attempted | protection enablement | |
| | | tampering | of malicious actors | |
| 11. | Proof-Of- | Data certified by | Unique, | GPDR Certification - Having the |
| | Integrity | using cryptographic | mathematically | ability to demonstrate that data |
| | | identifiers | certifiable statement | has not been tampered with is |
| | | (SHA256) that | that the data received | crucial for both individuals and |
| | | irrefutably represent | is exactly as was | businesses. |
| | | User data, and data | transmitted. When | |
| | | is timestamped in a | mathematical truth | |
| | | database (the | replaces trust | |
| | | blockchain) that | | |
| | | cannot be changed | | |
| 12. | Scales and | The larger the | DTxLedger DLT can | |
| | becomes faster | distributed cloud, | restore files | |
| | over time | the faster parallel | permanently deleted | |
| | | recall becomes | by ransomware, other | |
| | | | malware, or accidental | |
| 13. | 80% D5 | Malware and | Ransomware | |
| | damage | malicious actors | Immunity | |
| | resistance | thwarted from | | |
| | | interrupting | | |
| | | operations | | |
| 14. | Proof-Of- | Cross-Domain | Different security | |
| | Compartment | Solution (CDS) | compartments can | |
| | | | interoperate from the | |
| | | | distributed VIN | |
| 15. | Proof-Of- | Secure attribution | | |
| | Ownership | that can be | | |
| | | independently | | |
| | | verified | | |
| 16. | Proof of | Ensure and certify | Ensure and certify that | Users can seamlessly and |
| | existence | that a document, | a dataset existed at a | irrefutably prove the exact |
| | | email or dataset | certain point in time. | moment data existed for legal, |
| | | existed at a certain | | compliance and business |
| | | point in time. | | purposes. |
| | | Timestamping | | |
| | | critical for | | |
| | | contracts, research | | |
| | | data, medical | | |
| | | records and | | |
| | | computer logs | | |
| 17. | Proof of receipt | Certify that a | Prove that someone | |
| | | specific recipient | has received the data | |
| | | received your | with clear and | |
| | | communication in | unmodifiable records. | |
| | | time | | |
| 18. | Security | The databases used | Immunity to Hackers - | |
| | | are secured by a | There is no quantum | |
| | | network of | computer that could | |
| | | computers | provide enough power | |
| | | distributed | to hack this entangled, | |
| | | anywhere. Each one | distributed, data | |
| | | of these computers | system for | |
| | | runs an LVM node | transmission, record | |
| | | processor that | keeping and | |
| | | makes these | transactions. | |
| | | databases secure | | |
| | | and immutable. | | |
| 19. | Privacy | Data not publicly | Personal Confidence - | |
| | | visible. Crypto | No way to reconstruct | |
| | | algorithms used to | content from any | |
| | | register unique | identifier because they | |
| | | identifier of data | are entangled and | |
| | | embedded and | holographically | |
| | | entangled across the | superposition-ed in a | |
| | | blockchain LVM | massive distributed | |
| | | nodes. | nodal space. | |
| 20. | Transparency | Both Bitcoin and | Personalized Control | The proofs of the integrity, |
| | | Ethereum | of owned data - | existence and ownership of such |
| | | blockchains are | anyone whose identity | content can be independently |
| | | fully distributed, | is bound to the data | verified by mathematical proofs |
| | | permissionless but | can access them from | validated by subject matter |
| | | unfortunately | anywhere in the world | experts such as: sysadmin, a |
| | | opaque due to | at any time. | judge in court, a digital forensic |
| | | mixers and | | or a lawyer. |
| | | tumblers: the LVM | | |
| | | distributed ledger is | | |
| | | transparent. | | |

Table 2 below provides an overview of Operational Key Performance Indicators (KPIs) for the commercial product built out and based on system 100.

TABLE 2
Operational Key Performance Indicators (KPIs)

| Key, Critical | | | |
|---|---|---|---|
| Components | Application Requirement | Predicted Performance | Tested Performance |
| Proof of | Transcode data | 100% data integrity | 100% data integrity achieved |
| Integrity | transmissions such that | maintained with up to 80% | with up to 80% nodes |
| | data integrity is maintained | of network nodes | unavailable using varied |
| | between a sender and | unavailable for transmission | levels of distributed |
| | receiver using Distributed | | redundancy. |
| | Ledger technologies | | |
| Cryptographic | Provide Cryptographic | Receipts sent 100% of the | Receipts were sent and |
| Receipts | Receipt from Sender to | time on alternate channel | received successfully 100% |
| | Receiver such that | separate from Data Tokens; | of the time. Delivered |
| | Receiver recovers sent data | 100% of data recovered by | receipts were 100% |
| | on separate channel from | Receiver | successful in retrieving |
| | data transmission channel | | shards from the network |
| Operator Alerts | Provide result of data | Green Alert-100% Data | User alerts successfully |
| (User | transmission to Sender and | Assured and Recovery; Red - | generated in appropriate |
| Notifications) | Receiver for each data | 0% Data Assured and/or | threat conditions |
| | transmission event | Data Recovery | |
| Network | Wired: IPv4, Wireless: | Wired: IPv4, Wireless: | WiFi, Cellular, Cloud |
| Environment | WiFi, Cellular; Multi-node; | WiFi, Cellular; Multi-node, | |
| | Cloud | Cloud | |
| User Devices | Windows, Android, | Windows, Android, Amazon | Data transmissions were |
| | Amazon AWS | AWS | successfully tested on |
| | | | Amazon AWS, Windows |
| | | | and Android devices |
| User Data | Sensor, Plans, Software; | Any data file type can be | 100 MB+ transactions |
| | 1 KB-2 GB sized files | transmitted | suffered increased latency |
| | | | due to encoding/decoding |
| | | | operations. This can be |
| | | | solved by further algorithm |
| | | | optimization and hardware |
| | | | deployment in the follow-on |
| | | | phase |
| Timely | Real Time/Near Real Time | Real time: Normal Network | Network transactions |
| | [Real-time dependent on | latency +.1 sec; Near Real | (upload/download) occurred |
| | User Network Service | Time: Normal Network | in real time. |
| | Level Agreement (SLA)] | latency +5 sec | |
| Cyber Attack | Threats (Nominal, | 100% data integrity and data | For larger Transmission sizes - |
| Resilient | Unintentional Errors, | availability from 0%-80% of | met 100% data integrity |
| | Intentional Errors) | data and/or Network | when up to 80% of network |
| | | degraded | was degraded; results varied |
| | | | based on Transmission & |
| | | | shard Sizes |

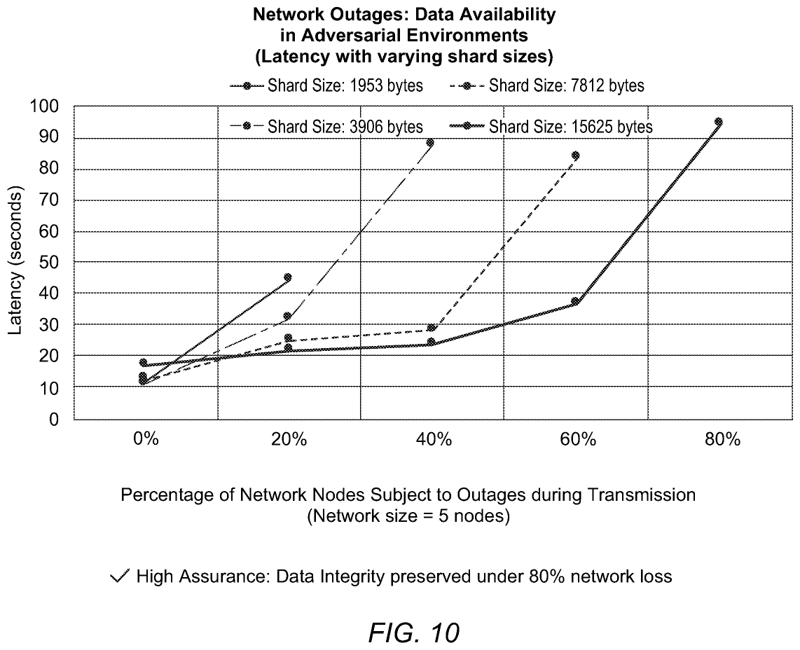

FIG. 10 is a graph describing data availability in adversarial environments during network outages to better demonstrate features of data integrity. In light of ID 13 from Table 1 and the KPI around Data Integrity shown in Table 2, FIG. 10 shows that the commercial product built and tested based on the example method and system can sustain 80% damage and still recover 100% data with Proof of Data Integrity (PoDI).

Accordingly, the example embodiments have presented a measurably secure distributed ledger technology that embeds advanced artificial intelligence and machine (AI/ML) nodes from edge to cloud. The example method and system uses dynamic intelligent smart-contracts adapted to detect and evade adversaries, as well to enable comprehensive Access Control Policies (ACP) and Distributed Global Communications Systems Controls (DGCSC) for scalable high-speed data in motion, data at rest integrity with authenticity proofs for measurably secure execution integrity and authenticity.

The above-described distributed ledger protocol withstands 80% of D5 (deception, denial, degradation, destruction, delay and jamming) effects by creating multipath Layer-2 redundant networks in which the data are dispersed, encrypted in a one-time pad protocol, rendered resilient via a special data cross-mixing process, and distributed parity; such achieves distributed data reconstruction with a 100% Proof of Integrity.

Additionally, the example embodiments may be configured so as to present a master global software catalog of blockchain-certifiable binaries and sources, to include sources even of non-collaborative application providers, in order to provide a quantifiable single view of truth in a digital supply chain (software, executables, data, identities and hardware). Moreover, the cryptographic protocol described herein replaces conventional cryptographic protocols with a super-scalable constant time protocol that is real-time at any scale for distributed data block integrity, authenticity validation, or verification.

As compared to others who use sharding, distribution of shards, and make various claims to post-quantum cryptography, it is believed that no other market solution provides “embedded at edge to cloud AI/ML controlled data agility” in the face of adversity that includes the blockchain at scalable real-time speeds. Such offers total communications dominance, proof of authenticity, and integrity, of both execution and data in motion or at rest. System dynamics according to the example embodiments thus provide a high-speed moving attack surface that even a Quantum-equipped adversary will find near impossible to track, comprehend, or poison.

Features of the invention can be implemented using some form of computer processor, which may drive one, some, or all of the DLVM core 105, smart contract subsystem 107 and the six software modules shown in FIG. 3 As one of ordinary skill in the art would recognize, the computer processor can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog or any other hardware description language and the code may be stored in an electronic memory directly within the FPGA or CPLD, or as a separate electronic memory. Further, the electronic memory may be non-volatile, such as ROM, EPROM, EEPROM or FLASH memory. The electronic memory may also be volatile, such as static or dynamic RAM (SRAM/DRAM), and a processor, such as a microcontroller or microprocessor, may be provided to manage the electronic memory as well as the interaction between the FPGA or CPLD and the electronic memory.

Alternatively, the computer processor may execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as a Xenon processor from Intel of America or an Opteron processor from AMD of America and an operating system, such as Microsoft VISTA, UNIX, Solaris, LINUX, Apple, MAC-OSX and other operating systems known to those skilled in the art.

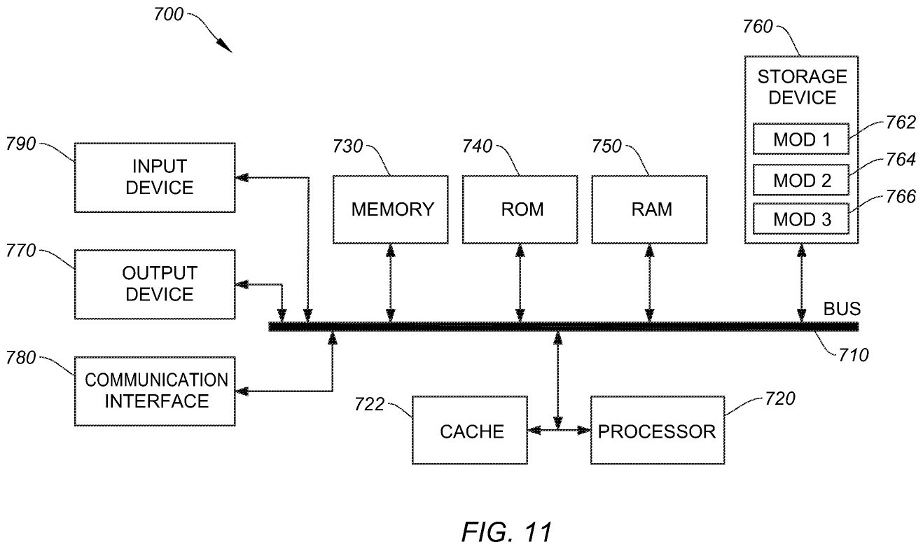

FIG. 11 is a block diagram of an exemplary computing device to drive the DLVM 105, smart contract subsystem 107, and software modules 110 to 160 of FIG. 3, so as to implement the example method 10. Namely, a description of a basic general-purpose computer system or computing device in FIG. 11 can be employed to practice the concepts, methods, and techniques disclosed. With reference to FIG. 11, an exemplary computer system and/or computing device 700 includes a processing unit (CPU or processor) 720 and a system bus 710 that couples various system components including the system memory 730 such as read only memory (ROM) 740 and random-access memory (RAM) 750 to the processor 720. The system 700 can include a cache 722 of high-speed memory connected directly with, in close proximity to, or integrated as part of the processor 720.

The system 700 copies data from the memory 730 and/or the storage device 760 to the cache 722 for quick access by the processor 720. In this way, the cache 722 provides a performance boost that avoids processor 720 delays while waiting for data. These and other modules can control or be configured to control the processor 720 to perform various operations or actions.

Other system memory 730 may be available for use as well. The memory 730 can include multiple different types of memory with different performance characteristics. It can be appreciated that the example blockchain-based nonprofit exchange 70 may operate on a computing device 700 with more than one processor 720 or on a group or cluster of computing devices networked together to provide greater processing capability.

The processor 720 can include any general-purpose processor and a hardware module or software module (inclusive of software modules 100-160 shown in FIG. 3), such as a module 1 762, a module 2 764, and a module 3 766 stored in storage device 760, configured to control the processor 720 as well as a special-purpose processor where software instructions are incorporated into the processor. The processor 720 may be a self-contained computing system, containing multiple cores or processors, a bus, memory controller, cache, etc. A multi-core processor may be symmetric or asymmetric. The processor 720 can include multiple processors, such as a system having multiple, physically separate processors in different sockets, or a system having multiple processor cores on a single physical chip.

Similarly, the processor 720 can include multiple distributed processors located in multiple separate computing devices, but working together such as via a communications network. Multiple processors or processor cores can share resources, such as memory 730 or the cache 722, or can operate using independent resources. The processor 720 can include one or more of a state machine, an application specific integrated circuit (ASIC), or a programmable gate array (PGA) including a field PGA.

The system bus 710 may be any of several types of bus structures including a memory bus or memory controller, a peripheral bus, and a local bus using any of a variety of bus architectures. A basic input/output (BIOS) stored in ROM 740 or the like, may provide the basic routine that helps to transfer information between elements within the computing device 700, such as during start-up.

The computing device 700 further includes storage devices 760 or computer-readable storage media such as a hard disk drive, a magnetic disk drive, an optical disk drive, tape drive, solid-state drive, RAM drive, removable storage devices, redundant array of inexpensive disks (RAID), hybrid storage device, or the like. The storage device 760 can include software modules 762, 764, 766 for controlling the processor 720.

The system 700 can include other hardware or software modules. The storage device 760 is connected to the system bus 710 by a drive interface. The drives and associated computer-readable storage devices provide nonvolatile storage of computer-readable instructions, data structures, program modules and other data for the computing device 700. In one aspect, a hardware module that performs a particular function includes the software component stored in a tangible computer-readable storage device in connection with the necessary hardware components, such as the processor 720, bus 710, display 770, and so forth, to carry out a particular function. In another aspect, the system can use a processor and computer-readable storage device to store instructions which, when executed by the processor, cause the processor to perform operations, a method or other specific actions.

The basic components and appropriate variations can be modified depending on the type of device, such as whether the device 700 is a small, handheld computing device, a desktop computer, or a computer server. When the processor 720 executes instructions to perform “operations”, the processor 720 can perform the operations directly and/or facilitate, direct, or cooperate with another device or component to perform the operations.

Although the exemplary computer system 700 employs a hard disk 760, other types of computer-readable storage devices which can store data that are accessible by a computer, such as magnetic cassettes, flash memory cards, digital versatile disks (DVDs), cartridges, random access memories (RAMs) 750, read only memory (ROM) 740, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 700, an input device 790 represents any number of input mechanisms. For example, a smart electronic device (smartphone, tablet, PDA and the like) can be accessed using an input device 790 such as a touch screen or pointing device (e.g., a mouse). Functions or outputs graphically shown on an output device 770 can be triggered by a user's finger where the input device 790 is a touch input, or with a cursor when the input device 790 is a mouse, or with the game player's eyes when the input device 216 is an eye tracker. Alternatively, functions or outputs of the system 700 graphically shown on a display can be triggered based on a user's facial or physical expression where the input device 790 is a camera with appropriate gesture tracking technology, with voice when the input device 790 is a microphone with appropriate voice recognition technology, or by thoughts when the input device 790 is a brain-computer interface.

The output device 770 can also be one or more of a number of output mechanisms known to those of skill in the art. In some instances, multimodal systems enable a user to provide multiple types of input to communicate with the computing device 700. The communications interface 780 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system 700 example is presented as including individual functional blocks including functional blocks labeled as a “processor” or processor 720. The functions these blocks represent may be provided through the use of either shared or dedicated hardware, including, but not limited to, hardware capable of executing software and hardware, such as a processor 720, that is purpose-built to operate as an equivalent to software executing on a general-purpose processor. For example the functions of one or more processors presented in FIG. 11 may be provided by a single shared processor or multiple processors. (Use of the term “processor” should not be construed to refer exclusively to hardware capable of executing software.) Illustrative examples may include microprocessor and/or digital signal processor (DSP) hardware, read-only memory (ROM) 740 for storing software performing the operations described below, and random-access memory (RAM) 750 for storing results. Very large-scale integration (VLSI) hardware examples, as well as custom VLSI circuitry in combination with a general-purpose DSP circuit, may also be provided.

The logical operations of the various examples are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 700 shown in FIG. 11 can practice all or part of the recited method(s), can be a part of the recited system 100 shown in FIG. 3, and/or can operate according to instructions in any recited tangible computer-readable storage devices. Such logical operations can be implemented as modules configured to control the processor 720 to perform particular functions according to the programming of the module.

For example, FIG. 11 illustrates three modules Mod1 762, Mod2 764 and Mod3 766 which are modules configured to control the processor 720. These modules may be stored on the storage device 760 and loaded into RAM 750 or memory 730 at runtime or may be stored in other computer-readable memory locations.

One or more parts of the example computer system or computing device 700, up to and including the entire computing device 700, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 720 can include all types of processors disclosed herein, including a virtual processor. However, when referring to a virtual processor, the processor 720 includes the software components associated with executing the virtual processor in a virtualization layer and underlying hardware necessary to execute the virtualization layer. The system 700 can include a physical or virtual processor 720 that receive instructions stored in a computer-readable storage device, which cause the processor 720 to perform certain operations. When referring to a virtual processor 720, the system also includes the underlying physical hardware executing the virtual processor 720.

The present invention, in its various embodiments, configurations, and aspects, includes components, systems and/or apparatuses substantially as depicted and described herein, including various embodiments, sub-combinations, and subsets thereof. Those of skill in the art will understand how to make and use the present invention after understanding the present disclosure. The present invention, in its various embodiments, configurations, and aspects, includes providing devices in the absence of items not depicted and/or described herein or in various embodiments, configurations, or aspects hereof, including in the absence of such items as may have been used in previous devices, e.g., for improving performance, achieving ease and\or reducing cost of implementation.

The foregoing discussion of the example embodiments has been presented for purposes of illustration and description, and is not intended to limit the example embodiments to the form or forms disclosed herein. In the foregoing detailed description for example, various features which constitute the invention are grouped together in one or more embodiments, configurations, or aspects for the purpose of streamlining the disclosure. The features of the embodiments, configurations, or aspects thereof may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this detailed description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures to those claimed, whether or not such alternate, interchangeable and/or equivalent structures disclosed herein, and without intending to publicly dedicate any patentable subject matter.

I claim:

1. A method executed by one or more computing devices for encoding data to be transmitted from sender to receiver over a distributed network, comprising:
fractionalizing an original data record to be transmitted by the sender to the receiver into fractionalized shards, each fractionalized shard containing at least a portion of the data in the original data record,
encrypting each of the fractionalized shards, each encrypted shard including encoded data of the original data record,
subjecting each encrypted shard to polar coding so as to generate a plurality of indistinguishable and independent polarized tokens, and
dispersing each of the polarized tokens using superimposed coding to create a plurality of holographic tokens for transmission, the holographic tokens collectively representative of the encoded data of the original data record,
wherein the fractionalizing, encrypting, subjecting, and dispersing steps are performed by computer software adapted to run on computer hardware.

2. The method of claim 1, wherein the plurality of holographic tokens are subject to transmission via blockchain records to one or more nodes in the distributed network for access by the receiver.

3. The method of claim 2, wherein upon the receiver being confirmed as a trusted public key infrastructure (PKI) party so as to gather the plurality of holographic tokens from the nodes of the network that correspond to the original data record, the gathered holographic tokens are subjected to a reverse processing which transforms the holographic tokens back into the encrypted shards, with the encrypted shards further decrypted into the fractionalized shards that are then reassembled into the original data record transmitted by the sender.

4. The method of claim 2, wherein in transmission via the blockchain records, the plurality of holographic tokens are randomly spread out to nodes on the distributed network.

5. The method of claim 2, wherein upon arrival at a node, each of the plurality of holographic tokens are randomly intermixed with other holographic tokens via entanglement to homogenize identities of the holographic tokens such that the holographic tokens become hidden.

6. The method of claim 1, wherein dispersing each of the polarized tokens using superimposed coding further includes using a distributed parity model randomly generating superimposed codes to transform each polarized token into the holographic token with a redundant array structure and a distributed parity representation.

7. The method of claim 1, wherein
the plurality of holographic tokens are randomly spread out to nodes of the distributed network upon transmission via blockchain records to the nodes for access by the receiver, and
encrypting each of the shards further includes generating a shard key for each shard and creating a Proof of Data Integrity (PoDI) cryptographic receipt, the shard key of each shard gathered into the created PoDI cryptographic receipt.

8. The method of claim 7, wherein
the receiver is required to be confirmed as a trusted PKI party in order to gain access to the holographic tokens at the nodes via the PoDI cryptographic receipt,
a smart contract sends the PoDI cryptographic receipt on an out-of-band side channel to the receiver by generating several one-time pad (OTP) private keys for the PKI process of exchanges with the receiver, and
through a process of PKI exchanges and authentication, the receiver is confirmed as a trusted party.

9. The method of claim 8, wherein the receiver receives a new smart contract with the PoDI cryptographic receipt which represents a map of the dispersed parts and locations of the holographic tokens on nodes of the network.

10. The method of claim 9, wherein
the receiver uses the PoDI cryptographic receipt to gather holographic tokens at various dispersed locations on the nodes which correspond to the original data record,
the gathered holographic tokens are subjected to a reverse processing which transforms the holographic tokens back into the encrypted shards, and
the encrypted shards are decrypted into the fractionalized shards that are then reassembled into the original data record transmitted by the sender.

11. The method of claim 1, wherein the holographic tokens that collectively represent the encoded data of the original data record cannot be cloned.

12. A computer system adapted for encoding data to be transmitted from sender to receiver over a distributed network, the system comprising:
a processing hardware set, and
a computer-readable storage device medium, wherein the processing hardware set is structured, connected and/or programmed to run program instructions stored on the computer-readable storage medium instructions and associated data, the program instructions including at least:
a user module programmed to accept an original data record of the sender for transmission to the receiver, and to fractionalize the original data record into a plurality of fractionalized shards, each fractionalized shard containing at least a portion of the data in the original data record,
a symmetric cryptographic module programmed to encrypt each of the fractionalized shards, each encrypted shard including encoded data of the original data record,
an error correction module programmed to subject each encrypted shard to polar coding so as to generate a plurality of indistinguishable and independent polarized tokens, and
a resilience module programmed to disperse each of the polarized tokens using superimposed coding to create a plurality of holographic tokens for transmission, the holographic tokens collectively representative of the encoded data of the original data record.

13. The system of claim 12, wherein the plurality of holographic tokens are subject to transmission via blockchain records to one or more nodes in the distributed network for access by the receiver.

14. The system of claim 13, wherein upon the receiver being confirmed as a trusted public key infrastructure (PKI) party so as to gather the plurality of holographic tokens from the nodes of the network that correspond to the original data record, the gathered holographic tokens are subjected to a reverse processing which transforms the holographic tokens back into the encrypted shards, the encrypted shards decrypted into the fractionalized shards that are then reassembled into the original data record transmitted by the sender.

15. The system of claim 13, further comprising a hologram data module programmed to:
randomly spread the holographic tokens out across the nodes of the network upon transmission and, upon arrival of the holographic tokens at the nodes,
direct random intermixing of each of the plurality of holographic tokens at the nodes with other holographic tokens via entanglement to homogenize identities of the holographic tokens such that the holographic tokens become hidden.

16. The system of claim 12, wherein the resilience module is further programmed to use a distributed parity model randomly generating superimposed codes to transform each polarized token into the holographic token with a redundant array structure and a distributed parity representation.

17. The system of claim 12, further comprising:
a hologram data module programmed to randomly spread the holographic tokens out across the nodes of the distributed network upon transmission via blockchain records to the nodes for access by the receiver, wherein
the symmetric cryptographic module is further programmed to:
generate a shard key for each shard, and
create a Proof of Data Integrity (PoDI) cryptographic receipt, the shard key of each shard gathered into the created PoDI cryptographic receipt.

18. The system of claim 17, wherein the receiver is required to be confirmed as a trusted PKI party in order to gain access to the holographic tokens at the nodes via the PoDI cryptographic receipt, the system further comprising:
an asymmetric cryptographic module programmed, under direction of a smart contract, to send the PoDI cryptographic receipt on an out-of-band side channel to the receiver by generating several one-time pad (OTP) private keys for the PM process of exchanges with the receiver and, through a process of PKI exchanges and authentication, to confirm that the receiver is a trusted PKI party.

19. The system of claim 18, wherein the receiver confirmed as a trusted PKI party receives a new smart contract with the PoDI cryptographic receipt which represents a map of various dispersed locations of the holographic tokens on nodes of the network.

20. The system of claim 19, wherein
the receiver uses the PoDI cryptographic receipt to gather holographic tokens on the nodes which correspond to the original data record,
the gathered holographic tokens are subjected to a reverse processing which transforms the holographic tokens back into the encrypted shards, and
the encrypted shards are decrypted into the fractionalized shards that are then reassembled into the original data record transmitted by the sender.

21. A method of assuring integrity of data transmission between a sender and receiver in a communication system, comprising:
fractionalizing original data from the sender into fractionalized shards, each fractionalized shard containing at least a portion of the data in the original data record,
breaking each fractionalized shard into an indistinguishable polarized token by generating a private shard key for each fractionalized shard, encrypting each shard, and then encapsulating essential information of the encrypted shard, the essential information representing at least a portion of the data in the original data record, into polarized independent tokens using polar-coding.
dispersing the polarized tokens using a distributed parity model randomly generating superimposed codes to thereby create a plurality of holographic tokens,
randomly spreading the plurality of holographic tokens out across nodes of the communication system upon transmission and, upon arrival of the holographic tokens at the nodes,
intermixing each of the plurality of holographic tokens at the nodes with other holographic tokens via entanglement to homogenize identities of the holographic tokens such that the holographic tokens become hidden.

22. The method of claim 21, wherein encrypting each shard further includes creating a Proof of Data Integrity (PoDI) cryptographic receipt, the private shard key of each shard gathered into the created PoDI cryptographic receipt.

23. The method of claim 22, wherein
the receiver is required to be confirmed as a trusted PKI party in order to gain access to the holographic tokens at the nodes via the PoDI cryptographic receipt,
a smart contract sends the PoDI cryptographic receipt on an out-of-band side channel to the receiver by generating several one-time pad (OTP) private keys for the PKI process of exchanges with the receiver, and
through a process of PKI exchanges and authentication, the receiver is confirmed as a trusted party by the smart contract.

24. The method of claim 23, wherein the receiver receives a new smart contract with the PoDI cryptographic receipt which represents a map of the dispersed parts and locations of the plurality of holographic tokens on nodes of the network.

25. The method of claim 24, wherein
the receiver uses the PoDI cryptographic receipt to gather holographic tokens on the nodes which correspond to the original data record,
the gathered holographic tokens are subjected to a reverse processing which transforms the holographic tokens back into the encrypted, fractionalized shards, and
the encrypted shards are decrypted back into the fractionalized shards that are then reassembled into the original data record transmitted by the sender.

26. The method of claim 21, wherein the holographic tokens that collectively represent the encoded data of the original data record cannot be cloned.
